(19) United States
(12) Patent Application Publication
(10) Pub. No.: US 2025/0066176 A1
(43) Pub. Date: Feb. 27, 2025

(54) BOOM LENGTH SENSING

(71) Applicant: Oshkosh Corporation, Oshkosh, WI (US)

(72) Inventors: Wenton Miller, Oshkosh, WI (US); Scott Riley, Oshkosh, WI (US); Aaron Powers, Oshkosh, WI (US); James Smyly, Oshkosh, WI (US)

(73) Assignee: Oshkosh Corporation, Oshkosh, WI (US)

(21) Appl. No.: 18/813,591

(22) Filed: Aug. 23, 2024

Related U.S. Application Data
(60) Provisional application No. 63/578,593, filed on Aug. 24, 2023.
(60) Provisional application No. 63/654,626, filed on May 31, 2024.

(51) Int. Cl. B66F 17/00; G01D 5/16; G01D 5/20; G01D 5/48

(52) U.S. Cl. CPC B66F 17/006; G01D 5/16; G01D 5/20; G01D 5/48

(57) ABSTRACT

A system may include a boom assembly comprising a base member and an extension member. The system may include a hydraulic assembly comprising: a cylinder housing having an internal cavity, a piston positioned partially within the internal cavity and coupled to the extension member at a distal end of the piston, a piston head coupled to the piston at a proximal end of the piston, the piston head located within the cylinder, a pressure tube coupled to the cylinder and positioned within the internal cavity, a sensor element extending within the pressure tube, and a magnet coupled to the piston and proximate at least a portion of the sensor element.

### CROSS-REFERENCE TO RELATED PATENT APPLICATION

This application claims the benefit of and priority to U.S. Provisional Patent Application No. 63/578,593, filed Aug. 24, 2023; and U.S. Provisional Patent Application No. 63/654,626, filed May 31, 2024, all of which are incorporated by reference herein in their entirety.

### BACKGROUND

The present disclosure relates to lift devices. More specifically, the present disclosure measuring the position of lift devices.

### SUMMARY

In some aspects, the techniques described herein relate to a lift device including: a boom assembly including a base member and an extension member; and a hydraulic assembly including: a cylinder housing having an internal cavity, a piston positioned at least partially within the internal cavity and coupled to the extension member at a distal end of the piston, a piston head coupled to the piston at a proximal portion of the piston, the piston head located within the cylinder, a pressure tube extending through the piston head and at least a portion of the piston, a sensor element extending within the pressure tube, and a magnet positioned between the piston head and the proximal end of the piston.

In some aspects, the techniques described herein relate to a lift device, further including a first magnet spacer positionally proximate the magnet at a first face of the magnet and a second magnet spacer positionally proximate the magnet at a second face of the magnet.

In some aspects, the techniques described herein relate to a lift device, wherein the magnet is a hollow cylinder radially disposed about the pressure tube.

In some aspects, the techniques described herein relate to a lift device, wherein the magnet is positioned between an internal face of the piston head and a proximal face of the cylinder.

In some aspects, the techniques described herein relate to a lift device, further including: a retention plate having a first face positionally proximate the proximal face of the cylinder; a first spacer having a first spacer face positionally proximate a second face of the retention plate and a second spacer face of the first spacer positionally proximate a first magnet face of the magnet; and a second spacer having a third spacer face positionally proximate a second magnet face of the magnet.

In some aspects, the techniques described herein relate to a lift device, further including a wave washer having a first washer face positionally proximate a fourth spacer face of the second spacer, and a second washer face positionally proximate an internal face of the piston head.

In some aspects, the techniques described herein relate to a lift device, wherein a fourth spacer face of the second spacer is positionally proximate an internal face of the piston head.

In some aspects, the techniques described herein relate to a lift device, wherein the sensor element is magnetorestrictive wire.

In some aspects, the techniques described herein relate to a lift device, further including a plug coupled to a distal end of the pressure tube, the plug sealing an interior of the pressure tube from the interior of the cylinder.

In some aspects, the techniques described herein relate to a lift device, wherein the sensor element extends through a position sensor, wherein the position sensor is an induction pickup coil.

In some aspects, the techniques described herein relate to a lift device including: a base assembly; a boom assembly coupled with the base assembly and configured to extend and retract, the boom assembly including: an extension member, a base member, configured to house the extension member, a cylinder coupled to the base member, and a piston positioned at least partially within the cylinder and coupled to the extension member and configured to extend the extension member; a platform assembly coupled with an end of the extension member of the boom assembly, the platform assembly configured to be raised and lowered by the boom assembly; and a control system including processing circuitry configured to: receive, from a sensor internal to the cylinder, a signal corresponding to a position of the extension member in relation to the base member, assign a value to the signal, determine, based on the value, a position of the extension member, and transmit the position of the extension member.

In some aspects, the techniques described herein relate to a lift device, wherein the sensor uses microwaves to measure the position of the extension member.

In some aspects, the techniques described herein relate to a lift device, wherein the sensor is a magnetorestrictive position sensor housed within a pressure tube extending within the cylinder.

In some aspects, the techniques described herein relate to a lift device, wherein the sensor uses microwaves to measure the position of the extension member.

In some aspects, the techniques described herein relate to a lift device including: a base assembly; a boom assembly coupled with the base assembly and configured to extend and retract, the boom assembly including: an extension member, a base member, configured to house the extension member, and a cylinder coupled to the base member and the extension member and configured to extend the extension member; a platform assembly coupled with an end of the extension member of the boom assembly, the platform assembly configured to be raised and lowered by the boom assembly; and a control system including processing circuitry configured to: receive, from a sensor external to the cylinder, a signal corresponding to a position of the extension member in relation to the base member; assign a value to the signal; determine, based on the value, a position of the extension member; and transmit the position of the extension member.

In some aspects, the techniques described herein relate to a lift device, wherein the sensor is a magnetorestrictive sensor including a magnet and a sensing element.

In some aspects, the techniques described herein relate to a lift device, wherein the magnet is coupled to the base member.

In some aspects, the techniques described herein relate to a lift device, wherein the magnet is coupled to the extension member.

In some aspects, the techniques described herein relate to a lift device, further including: a magnetorestrictive wire coupled to the base member; and a magnet coupled to the extension member.

In some aspects, the techniques described herein relate to a lift device, wherein the magnet moves relative to the magnetorestrictive wire during movement of the extension member.

### BRIEF DESCRIPTION OF THE DRAWINGS

FIG. 1 is a perspective view of a lift device, according to some embodiments

FIG. 2 is a perspective view of a base of the lift device of FIG. 1, according to some embodiments.

FIG. 3 is a perspective view of an axle assembly of the lift device of FIG. 1, according to some embodiments.

FIG. 4 is a perspective view of the platform assembly of the lift device of FIG. 1, according to some embodiments.

FIG. 5A is a section view of a portion of a boom assembly with an internal position sensor of the lift device of FIG. 1, according to some embodiments.

FIG. 5B is a section view of a portion of the boom assembly of FIG. 5A with an internal position sensor, according to some embodiments.

FIG. 5C is a perspective view of a portion of the boom assembly of FIG. 5A with an internal position sensor, according to some embodiments.

FIG. 5D is a section view of a portion of a boom assembly, according to some embodiments.

FIG. 6A is a perspective view of a portion of a boom assembly with an external position sensor of the lift device of FIG. 1, according to some embodiments.

FIG. 6B is a perspective view of a portion of the boom assembly of FIG. 6A with an external position sensor, according to some embodiments.

FIG. 6C is a perspective view of a portion of the boom assembly of FIG. 6A with an external position sensor, according to some embodiments.

FIG. 7 is a perspective view of a portion of a boom assembly of the lift device of FIG. 1 with an external position sensor, according to some embodiments.

FIG. 8A is a perspective view of a boom assembly of FIG. 1 with an external position sensor, according to some embodiments.

FIG. 8B is a front view of the external position sensor of FIG. 8A, according to some embodiments.

FIG. 9 is a side view of the boom assembly of FIG. 1 with a position sensor, according to some embodiments.

FIG. 10A is a bottom view of the boom assembly of FIG. 1 with a position sensor, according to some embodiments.

FIG. 10B is a rear view of the boom assembly of FIG. 1 with a position sensor, according to some embodiments.

FIG. 11A is a perspective view of the boom assembly of FIG. 1 with an external position sensor, according to some embodiments.

FIG. 11B is a perspective view of the external position sensor of FIG. 11A, according to some embodiments.

FIG. 12A is a section view of the boom assembly of FIG. 1 with an internal position sensor, according to some embodiments.

FIG. 12B is a section view of the internal position sensor of FIG. 12A, according to some embodiments.

FIG. 13 is a side view of a boom assembly of FIG. 1 with a position sensor, according to some embodiments.

FIGS. 14A-14C illustrate various rear views of a position sensor, according to some embodiments.

FIG. 15 is a section view of an internal position sensor, according to an embodiment.

FIG. 16A is a perspective view of an external position sensor mounted on a hydraulic assembly, according to an embodiment.

FIG. 16B is a section view of the position sensor of FIG. 16A, according to an embodiment.

FIG. 17A is a perspective view of an external position sensor mounted between boom arms, according to an embodiment.

FIG. 17B is a section view of the position sensor of FIG. 17A, according to an embodiment.

FIG. 17C is a perspective view of a mounting element for the position sensor of FIG. 17A, according to an embodiment.

FIG. 18 is a side, section view of the position sensor of FIG. 17A, according to an embodiment.

FIG. 19 is a front, section view of the position sensor of FIG. 17A, according to an embodiment.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the figures, a lift device includes a control system that is configured to receive a user input and operate the lift device. During operation of the lift device, a position sensor disposed on or within a lift assembly determines the position of an extension member of the lift assembly and transmits the determined position to at least a display panel of the lift device. Various position sensor embodiments are disclosed herein.

### Lift Device

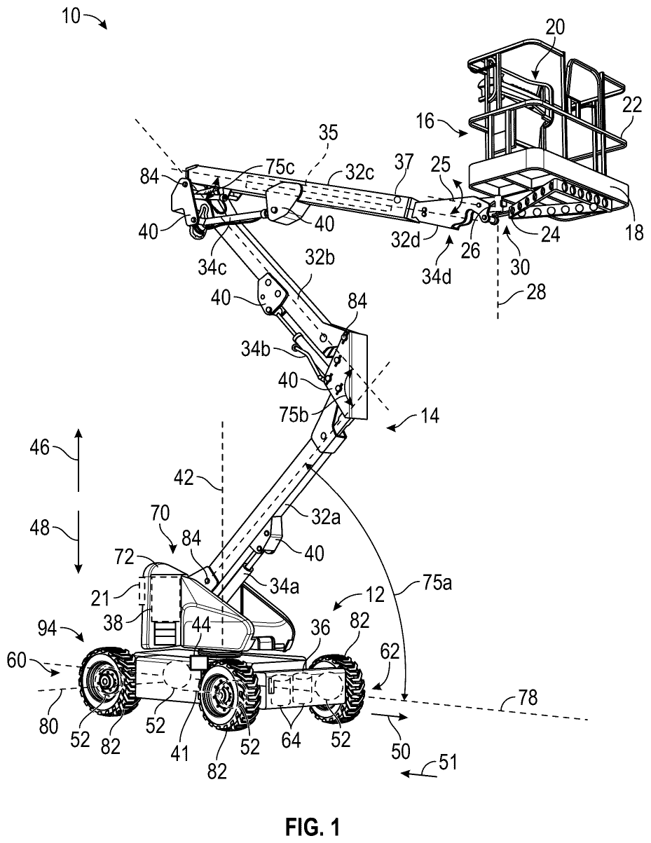

Referring to FIG. 1, a lifting apparatus, lift device, or mobile elevating work platform (MEWP) (e.g., a telehandler, an electric boom lift, a towable boom lift, a lift device, a fully electric boom lift, etc.), shown as lift device 10 includes a base assembly 12 (e.g., a base, a support assembly, a drivable support assembly, a support structure, a chassis, etc.), a platform assembly 16 (e.g., a platform, a terrace, etc.), and a lift assembly 14 (e.g., a boom, a boom lift assembly, a lifting apparatus, an articulated arm, a scissors lift, etc.). The lift device 10 includes a front end (e.g., a forward-facing end, a front portion, a front, etc.), shown as front 62, and a rear end (e.g., a rearward facing end, a back portion, a back, a rear, etc.,) shown as rear 60. The lift assembly 14 is configured to elevate the platform assembly 16 in an upward direction 46 (e.g., an upward vertical direction) relative to the base assembly 12. The lift assembly 14 is also configured to translate the platform assembly 16 in a downward direction 48 (e.g., a downward vertical direction). The lift assembly 14 is also configured to translate the platform assembly 16 in either a forward direction 50 (e.g., a forward longitudinal direction) or a rearward direction 51 (e.g., a rearward longitudinal direction). The lift assembly 14 generally facilitates performing a lifting function to raise and lower the platform assembly 16, as well as movement of the platform assembly 16 in various directions.

The base assembly 12 defines a longitudinal axis 78 and a lateral axis 80. The longitudinal axis 78 defines the forward direction 50 of lift device 10 and the rearward direction 51. The lift device 10 is configured to translate in the forward direction 50 and to translate backwards in the rearward direction 51. The base assembly 12 includes one or more wheels, tires, wheel assemblies, tractive elements, rotary elements, treads, etc., shown as tractive elements 82. The tractive elements 82 are configured to rotate to drive (e.g., propel, translate, steer, move, etc.) the lift device 10. The tractive elements 82 can each include an electric motor 52 (e.g., electric wheel motors) configured to drive the tractive elements 82 (e.g., to rotate tractive elements 82 to facilitate motion of the lift device 10). In other embodiments, the tractive elements 82 are configured to receive power (e.g., rotational mechanical energy) from electric motors 52 or through a drive train (e.g., a combination of any number and configuration of a shaft, an axle, a gear reduction, a gear train, a transmission, etc.). In some embodiments, one or more tractive elements 82 are driven by a prime mover 41 (e.g., electric motor, internal combustion engine, etc.) through a transmission. In some embodiments, a hydraulic system (e.g., one or more pumps, hydraulic motors, conduits, valves, etc.) transfers power (e.g., mechanical energy) from one or more electric motors 52 and/or the prime mover 41 to the tractive elements 82. The tractive elements 82 and electric motors 52 (or prime mover 41) can facilitate a driving and/or steering function of the lift device 10. In some embodiments, the electric motors 52 are optional, and the tractive elements 82 are powered or driven by an internal combustion engine.

With additional reference to FIG. 4, the platform assembly 16 is shown in further detail. The platform assembly 16 is configured to provide a work area for an operator of the lift device 10 to stand/rest upon. The platform assembly 16 can be pivotally coupled to an upper end of the lift assembly 14. The lift device 10 is configured to facilitate the operator accessing various elevated areas (e.g., lights, platforms, the sides of buildings, building scaffolding, trees, power lines, etc.). The lift device 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the base assembly 12, or to a ground surface that the base assembly 12 rests upon). In some embodiments, the lift device 10 uses internal combustion engines, hydraulics, a hydraulic system, pneumatic cylinders, etc.

The platform assembly 16 includes a base member, a base portion, a platform, a standing surface, a shelf, a work platform, a floor, a deck, etc., shown as a deck 18. The deck 18 provides a space (e.g., a floor surface) for a worker to stand upon as the platform assembly 16 is raised and lowered.

The platform assembly 16 includes a railing assembly including various members, beams, bars, guard rails, rails, railings, etc., shown as rails 22. The rails 22 extend along substantially an entire perimeter of the deck 18. The rails 22 provide one or more members for the operator of the lift device 10 to grasp while using the lift device 10 (e.g., to grasp while operating the lift device 10 to elevate the platform assembly 16). The rails 22 can include members that are substantially horizontal to the deck 18. The rails 22 can also include vertical structural members that couple with the substantially horizontal members. The vertical structural members can extend upwards from the deck 18.

The platform assembly 16 can include a human machine interface (HMI) (e.g., a user interface, an operator interface, etc.), shown as the user interface 20. The user interface 20 is configured to receive user inputs from the operator at or upon the platform assembly 16 to facilitate operation of the lift device 10. The user interface 20 can include any number of buttons, levers, switches, keys, etc., or any other user input device configured to receive a user input to operate the lift device 10. The user interface 20 may also provide information to the user (e.g., through one or more displays, lights, speakers, haptic feedback devices, etc.). The user interface 20 can be supported by one or more of the rails 22.

Referring to FIG. 1, the platform assembly 16 includes a frame 24 (e.g., structural members, support beams, a body, a structure, etc.) that extends at least partially below the deck 18. The frame 24 can be integrally formed with the deck 18. The frame 24 is configured to provide structural support for the deck 18 of the platform assembly 16. The frame 24 can include any number of structural members (e.g., beams, bars, I-beams, etc.) to support the deck 18. The frame 24 couples the platform assembly 16 with the lift assembly 14. The frame 24 may be rotatably or pivotally coupled with the lift assembly 14 to facilitate rotation of the platform assembly 16 about an axis 28 (e.g., a vertical axis). The frame 24 can also rotatably/pivotally couple with the lift assembly 14 such that the frame 24 and the platform assembly 16 can pivot about an axis 25 (e.g., a horizontal axis).

The lift assembly 14 includes one or more beams, articulated arms, bars, booms, arms, support members, boom sections, cantilever beams, etc., shown as lift arms 32a, 32b, and 32c. The lift arms are hingedly or rotatably coupled with each other at their ends. The lift arms can be hingedly or rotatably coupled to facilitate articulation of the lift assembly 14 and raising/lowering and/or horizontal movement of the platform assembly 16. The lift device 10 includes a lower lift arm 32a, a central or medial lift arm 32b, and an upper lift arm 32c. The lower lift arm 32a is configured to hingedly or rotatably couple at one end with the base assembly 12 to facilitate lifting (e.g., elevation) of the platform assembly 16. The lower lift arm 32a is configured to hingedly or rotatably couple at an opposite end with the medial lift arm 32b. Likewise, the medial lift arm 32b is configured to hingedly or rotatably couple with the upper lift arm 32c. The upper lift arm 32c can be configured to hingedly interface/couple and/or telescope with an intermediate lift arm 32d. The upper lift arm 32c can be referred to as “the jib” of the lift device 10. The intermediate lift arm 32d may extend into an inner volume of the upper lift arm 32c and extend and/or retract. The lower lift arm 32a and the medial lift arm 32b may be referred to as “the boom” of the overall lift device 10 assembly. The intermediate lift arm 32d can be configured to couple (e.g., rotatably, hingedly, etc.), with the platform assembly 16 to facilitate levelling of the platform assembly 16.

The lift arms 32 are driven to hinge or rotate relative to each other by actuators 34a, 34b, 34c, and 34d (e.g., electric linear actuators, linear electric arm actuators, hydraulic cylinders, etc.). The actuators 34a, 34b, 34c, and 34d can be mounted between adjacent lift arms to drive adjacent lift arms to hinge or pivot (e.g., rotate some angular amount) relative to each other about pivot points 84. The actuators 34a, 34b, 34c, and 34d can be mounted between adjacent lift arms using any of a foot bracket, a flange bracket, a clevis bracket, a trunnion bracket, etc. The actuators 34a, 34b, 34c, and 34d may be configured to extend or retract (e.g., increase in overall length, or decrease in overall length) to facilitate pivoting adjacent lift arms to pivot/hinge relative to each other, thereby articulating the lift arms and raising or lowering the platform assembly 16.

The actuators 34a, 34b, 34c, and 34d can be configured to extend (e.g., increase in length) to increase a value of an angle formed between adjacent lift arms 32. The angle can be defined between centerlines of adjacent lift arms 32 (e.g., centerlines that extend substantially through a center of the lift arms 32). For example, the actuator 34a is configured to extend/retract to increase/decrease the angle 75a defined between a centerline of the lower lift arm 32a and the longitudinal axis 78 (angle 75a can also be defined between the centerline of the lower lift arm 32a and a plane defined by the longitudinal axis 78 and lateral axis 80) and facilitate lifting of the platform assembly 16 (e.g., moving the platform assembly 16 at least partially along the upward direction 46). Likewise, the actuator 34b can be configured to retract to decrease the angle 75a to facilitate lowering of the platform assembly 16 (e.g., moving the platform assembly 16 at least partially along the downward direction 48). Similarly, the actuator 34b is configured to extend to increase the angle 75b defined between centerlines of the lower lift arm 32a and the medial lift arm 32b and facilitate elevating of the platform assembly 16. Similarly, the actuator 34b is configured to retract to decrease the angle 75b to facilitate lowering of the platform assembly 16. The electric actuator 34c is similarly configured to extend/retract to increase/decrease the angle 75c, respectively, to raise/lower the platform assembly 16. The actuators 34 may be hydraulic actuators, electric actuators, pneumatic actuators, etc.

The actuators 34a, 34b, 34c, and 34d can be mounted (e.g., rotatably coupled, pivotally coupled, etc.) to adjacent lift arms at mounts 40 (e.g., mounting members, mounting portions, attachment members, attachment portions, etc.). The mounts 40 can be positioned at any position along a length of each lift arm. For example, the mounts 40 can be positioned at a midpoint of each lift arm, and a lower end of each lift arm.

The intermediate lift arm 32d and the frame 24 are configured to pivotally interface/couple at a platform rotator 30 (e.g., a rotary actuator, a rotational electric actuator, a gear box, etc.). The platform rotator 30 facilitates rotation of the platform assembly 16 about the axis 28 relative to the intermediate lift arm 32d. In some embodiments, the platform rotator 30 is positioned between the frame 24 and the upper lift arm 32c and facilitates pivoting of the platform assembly 16 relative to the upper lift arm 32c. The axis 28 extends through a central pivot point of the platform rotator 30. The intermediate lift arm 32d can also be configured to articulate or bend such that a distal portion of the intermediate lift arm 32d pivots/rotates about the axis 25. The intermediate lift arm 32d can be driven to rotate/pivot about axis 25 by extension and retraction of the actuator 34d.

The intermediate lift arm 32d is also configured to extend/retract (e.g., telescope) along the upper lift arm 32c. In some embodiments, the lift assembly 14 includes a linear actuator (e.g., a hydraulic cylinder, an electric linear actuator, etc.), shown as extension actuator 35, that controls extension and retraction of the intermediate lift arm 32d relative to the upper lift arm 32c. In other embodiments, one more of the other arms of the lift assembly 14 include multiple telescoping sections that are configured to extend/retract relative to one another.

The platform assembly 16 is configured to be driven to pivot about the axis 28 (e.g., rotate about axis 28 in either a clockwise or a counter-clockwise direction) by an electric or hydraulic motor 26 (e.g., a rotary electric actuator, a stepper motor, a platform rotator, a platform electric motor, an electric platform rotator motor, etc.). The motor 26 (e.g., the pivot motor 26) can be configured to drive the frame 24 to pivot about the axis 28 relative to the upper lift arm 32c (or relative to the intermediate lift arm 32d). The motor 26 can be configured to drive a gear train to pivot the platform assembly 16 about the axis 28.

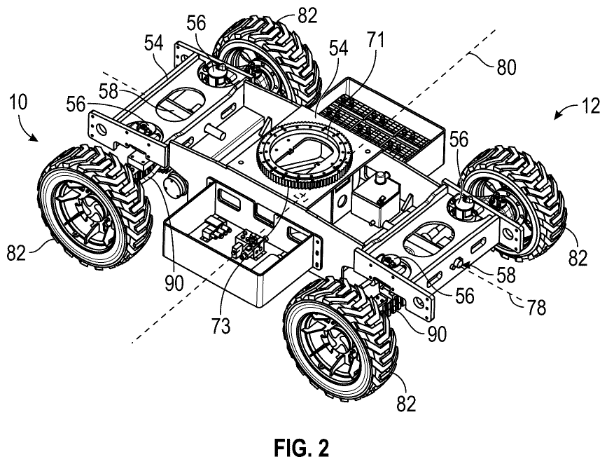

Referring to FIGS. 1 and 2, the lift assembly 14 is configured to pivotally or rotatably couple with the base assembly 12. The base assembly 12 includes a rotatable base member, a rotatable platform member, a fully electric turntable, etc., shown as a turntable 70. The lift assembly 14 is configured to rotatably/pivotally couple with the base assembly 12. The turntable 70 is rotatably coupled with a base, frame, structural support member, carriage, etc., of base assembly 12, shown as base 36. The turntable 70 is configured to rotate or pivot relative to the base 36. The turntable 70 can pivot/rotate about the central axis 42 relative to base 36, about a slew bearing 71 (e.g., the slew bearing 71 pivotally couples the turntable 70 to the base 36). The turntable 70 facilitates accessing various elevated and angularly offset locations at the platform assembly 16. The turntable 70 is configured to be driven to rotate or pivot relative to base 36 and about the slew bearing 71 by an electric motor, an electric turntable motor, an electric rotary actuator, a hydraulic motor, etc., shown as the turntable motor 44. The turntable motor 44 can be configured to drive a geared outer surface 73 of the slew bearing 71 that is rotatably coupled to the base 36 about the slew bearing 71 to rotate the turntable 70 relative to the base 36. The lower lift arm 32a is pivotally coupled with the turntable 70 (or with a turntable member 72 of the turntable 70) such that the lift assembly 14 and the platform assembly 16 rotate as the turntable 70 rotates about the central axis 42. In some embodiments, the turntable 70 is configured to rotate a complete 360 degrees about the central axis 42 relative to the base 36. In other embodiments, the turntable 70 is configured to rotate an angular amount less than 360 degrees about the central axis 42 relative to the base 36 (e.g., 270 degrees, 120 degrees, etc.).

The base assembly 12 includes one or more energy storage devices or power sources (e.g., capacitors, batteries, Lithium-Ion batteries, Nickel Cadmium batteries, fuel tanks, etc.), shown as batteries 64. The batteries 64 are configured to store energy in a form (e.g., in the form of chemical energy) that can be converted into electrical energy for the various electric motors and actuators of the lift device 10. The batteries 64 can be stored within the base 36. The lift device 10 includes a controller 38 that is configured to operate any of the motors, actuators, etc., of the lift device 10. The controller 38 can be configured to receive sensory input information from various sensors of the lift device 10, user inputs from the user interface 20 (or any other user input device such as a key-start or a push-button start), etc. The controller 38 can be configured to generate control signals for the various motors, actuators, etc., of the lift device 10 to operate any of the motors, actuators, electrically powered movers, etc., of the lift device 10. The batteries 64 are configured to power any of the motors, sensors, actuators, electric linear actuators, electrical devices, electrical movers, stepper motors, etc., of the lift device 10. The base assembly 12 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the lift device 10.

The batteries 64 are configured to deliver power to the motors 52 to drive the tractive elements 82. A rear set of tractive elements 82 can be configured to pivot to steer the lift device 10. In other embodiments, a front set of tractive elements 82 are configured to pivot to steer the lift device 10. In still other embodiments, both the front and the rear set of tractive elements 82 are configured to pivot (e.g., independently) to steer the lift device 10. In some examples, the base assembly 12 includes a steering system 150. The steering system 150 is configured to drive tractive elements 82 to pivot for a turn of the lift device 10. The steering system 150 can be configured to pivot the tractive elements 82 in pairs (e.g., to pivot a front pair of tractive elements 82), or can be configured to pivot tractive elements 82 independently (e.g., four-wheel steering for tight-turns).

It should be understood that while the lift device 10 as described herein is described with reference to batteries, electric motors, etc., the lift device 10 can be powered (e.g., for transportation and/or lifting the platform assembly 16) using one or more internal combustion engines, electric motors or actuators, hydraulic motors or actuators, pneumatic actuators, or any combination thereof.

In some embodiments, the base assembly 12 also includes a user interface 21 (e.g., a HMI, a user interface, a user input device, a display screen, etc.). In some embodiments, the user interface 21 is coupled to the base 36. In other embodiments, the user interface 21 is positioned on the turntable 70. The user interface 21 can be positioned on any side or surface of the base assembly 12 (e.g., on the front 62 of the base 36, on the rear 60 of the base 36, etc.).

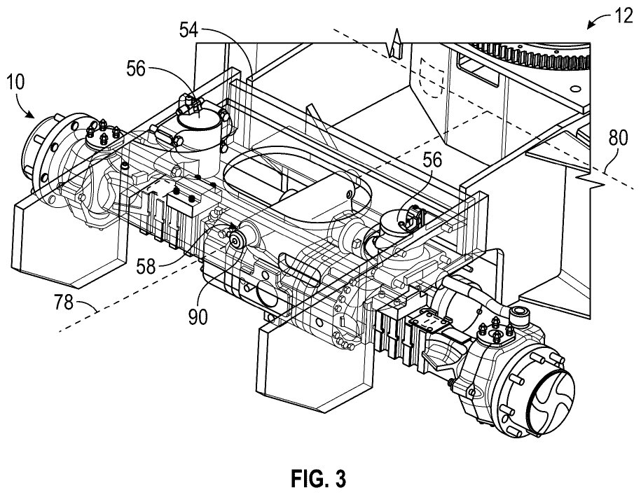

Referring now to FIGS. 2 and 3, the base assembly 12 includes a longitudinally extending frame member 54 (e.g., a rigid member, a structural support member, an axle, a base, a frame, a carriage, a chassis, etc.). The longitudinally extending frame member 54 provides structural support for the turntable 70 as well as the tractive elements 82. The longitudinally extending frame member 54 is pivotally coupled with lateral frame members 110 (e.g., axles, frame members, beams, bars, etc.) at opposite longitudinal ends of the longitudinally extending frame member 54. For example, the lateral frame members 110 may be pivotally coupled with the longitudinally extending frame member 54 at a front end and a rear end of the longitudinally extending frame member 54. The lateral frame members 110 can each be configured to pivot about a pivot joint 58 (e.g., about a longitudinal axis). The pivot joint 58 can include a pin and a receiving portion (e.g., a bore, an aperture, etc.). The pin of the pivot joint 58 is coupled to one of the lateral frame members 110 (e.g., a front lateral frame member 110 or a rear lateral frame member 110) or the longitudinally extending frame member 54 and the receiving portion is coupled to the other of the longitudinally extending frame member 54 and the lateral frame member 110. For example, the pin may be coupled with longitudinally extending frame member 54 and the receiving portion can be coupled with one of the lateral frame members 110 (e.g., integrally formed with the front lateral frame member 110).

In some embodiments, the longitudinally extending frame member 54 and the lateral frame members 110 are integrally formed or coupled (e.g., fastened, welded, riveted, etc.) to define the base 36. In still other embodiments, the base 36 is integrally formed with the longitudinally extending frame member 54 and/or the lateral frame members 110. In still other embodiments, the base 36 is coupled with the longitudinally extending frame member 54 and/or the lateral frame members 110.

The base assembly 12 includes one or more axle actuators 56 (e.g., electric linear actuators, electric axle actuators, electric levelling actuators, hydraulic cylinders, etc.). The axle actuators 56 can be linear actuators configured to receive power from the batteries 64, for example. The axle actuators 56 can be configured to extend or retract to contact a top surface of a corresponding one of the lateral frame members 110. When the axle actuators 56 extend, an end of a rod of the levelling actuators can contact the surface of lateral frame member 110 and prevent relative rotation between lateral frame member 110 and longitudinally extending frame member 54. In this way, the relative rotation/pivoting between the lateral frame member 110 and the longitudinally extending frame member 54 can be locked (e.g., to prevent rolling of the longitudinally extending frame member 54 relative to the lateral frame members 110 during operation of the lift assembly 14). The axle actuators 56 can receive power from the batteries 64, which can allow the axle actuators 56 to extend or retract. The axle actuators 56 receive control signals from controller 38.

### Boom Length Sensing System

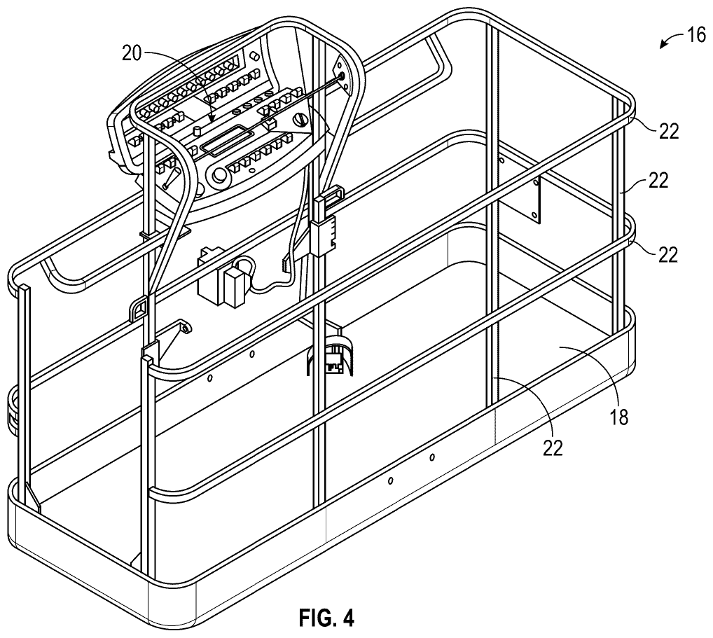

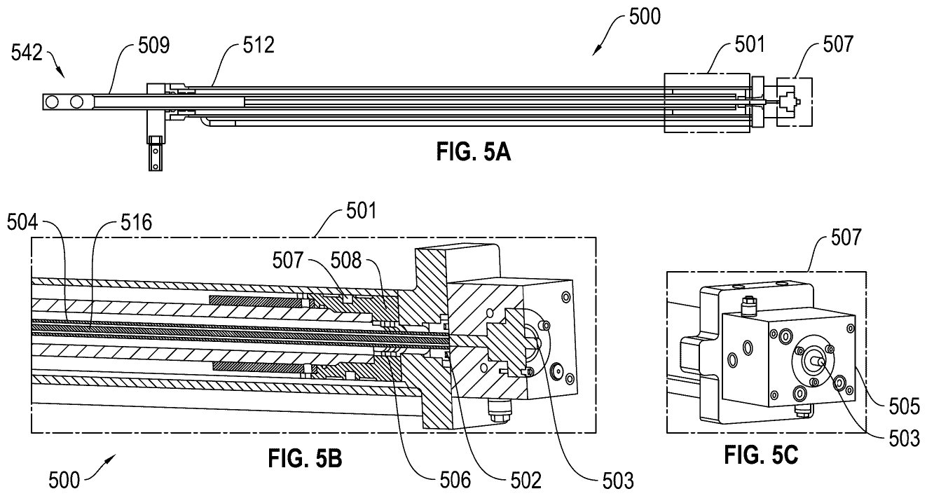

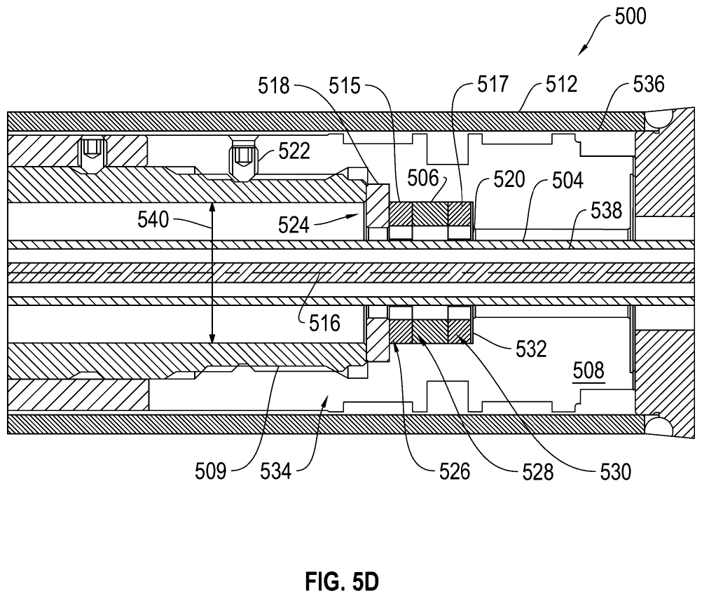

Referring to FIGS. 5A-19, the lift device 10 of FIG. 1 may comprise a position sensor (e.g., position sensor 37 of FIG. 1) disposed on or within the upper lift arm 32c and/or the intermediate lift arm 32d of FIG. 1 to determine the position of the intermediate lift arm 32d with relation to upper lift arm 32c.

Turning to FIG. 5A, a hydraulic assembly 500 is shown. The hydraulic assembly 500 may comprise a piston rod 509 and a cylinder 512, fluidly coupled to one another. Specifically, the piston rod 509 may be received within the cylinder 512. The piston rod 509 may include a seal 507 to separate a first portion of the cylinder 512 from a second portion of the cylinder 512, such that the two portions (e.g., the two inner volumes) are separated by the seal 507 as the piston rod 509 moves. Accordingly, the piston rod 509 may be extended from the cylinder 512 or retracted into the cylinder 512 by adding pressurized fluid (e.g., hydraulic oil) to one of the two inner volumes. The piston rod 509 is positioned within the cylinder 512, and the seal 507 creates a fluid-tight seal with an inner surface of the cylinder 512. The piston rod 509 may also be fixedly coupled to a piston rod 509, the piston rod 509 being coupled to a member of the lift assembly 14 of FIG. 1. In some embodiments, the piston rod 509 is coupled to the upper lift arm 32c and the cylinder 512 is coupled to the intermediate lift arm 32d. In this embodiment, as the piston and cylinder translate into an extended position by hydraulically pressurizing the second portion of the cylinder, the intermediate lift arm 32d moves into an extended position. In some embodiments, the piston rod 509 is coupled to the intermediate lift arm 32d and the cylinder is coupled to the upper lift arm 32c of FIG. 1. In substantially the same manner, the upper lift arm 32c and the intermediate lift arm 32d are adjusted into the extended position as the cylinder 512 and piston rod 509 extend.

The hydraulic assembly 500 may also comprise a position sensor 502. The position sensor 502 may be coupled to a second end of the cylinder 512. FIG. 5C illustrates the position sensor 502. As shown in FIG. 5B, the position sensor 502 may include a sensor element 516 inside a pressure tube 504 (the sensor element 516 being either flexible or rigid), a magnet 506, and a sensing unit 501 or sensor. The sensing unit 501 may be a Hall effect sensor or magnetorestrictive position sensor.

The magnetorestrictive position sensor is a type of sensor used to measure the position, displacement, or level of an object, such as the position of the piston rod 509 in the cylinder 512. The sensing unit 501 utilizes the principle of magnetostriction, which is the property of certain materials to change their shape or dimensions when subjected to a magnetic field. In some embodiments, the position sensor may include an induction pickup coil (e.g., a coil of conductive wire) that senses torsional strain pulses on the sensor element 516).

In a magnetorestrictive position sensor, a sensing element or waveguide (e.g., sensor element 516 inside the pressure tube 504) made of a magnetorestrictive material, such as Terfenol-D, Metglas 2605SC, cobalt ferrite, nickel, or Galfenol, is used. The sensing element may be a thin metal wire or rod (e.g., sensor element 516 inside the pressure tube 504) that is placed in close proximity to a permanent magnet (e.g., magnet 506).

When an electrical current pulse is passed through the sensor element 516 inside the pressure tube 504, it generates a magnetic field that interacts with the permanent magnet 506. This interaction causes the magnetorestrictive material (e.g., the sensor element 516 inside the pressure tube 504) to experience a strain, resulting in a mechanical wave or “strain wave” propagating along the sensor element 516 inside the pressure tube 504.

To determine the position of the piston rod 509 in the cylinder 512 (and by association, the position of the intermediate lift arm 32d in relation to the upper lift arm 32c), a pickup or transducer is placed along the waveguide to detect the strain wave. The transducer converts the mechanical strain into an electrical signal, which is then processed to determine the precise position of the object being measured.

In some embodiments, the position sensor 502 is a Hall effect sensor. The Hall effect sensor may function in the following manner to determine the position of the piston rod 509 in relation to the cylinder 512. The Hall effect sensor may comprise a thin strip or plate of semiconductor material (e.g., sensor element 516 inside the pressure tube 504) with current flowing through it. When a magnetic field is applied perpendicular to the direction of the current, the Lorentz force acts on the charge carriers (electrons or holes) within the material. The Lorentz force causes the charge carriers to be deflected towards one side of the semiconductor material, resulting in an accumulation of charge carriers on one edge and a depletion of charge carriers on the opposite edge. This creates a voltage difference, known as the Hall voltage, across the material. The Hall voltage may be measured using the position sensor's 502 built-in electrodes or contacts placed along the edges of the semiconductor strip. These electrodes pick up the voltage difference created by the Hall effect. The Hall voltage is proportional to the strength of the magnetic field and can be positive or negative depending on the polarity of the magnetic field and the type of charge carriers (electrons or holes) in the material. The output signal from the Hall effect sensor can be analog (continuous voltage) or digital (on/off signal) depending on the sensor's design and application. By measuring the Hall voltage, the Hall effect sensor can determine the presence, strength, and polarity of the magnetic field. It can detect magnetic fields from permanent magnets (e.g., magnet 506), electromagnets, or magnetic field changes induced by moving objects.

In embodiments with the sensor element 516 inside the pressure tube 504 being flexible, serviceability is increased, and the sensor element 516 inside the pressure tube 504 may be extracted from the cylinder 512 without contaminating the system by unscrewing the lid 503 from the sensing unit 501.

In operation of the lift device 10 of FIG. 1, upon the control system receiving a command to extend the intermediate lift arm 32d, the hydraulic assembly 500 pressurizes one of the two chambers of the cylinder 512 created by the piston rod 509 to apply a force upon a piston head 508 of the piston rod 509. This pressure causes the piston rod 509 to move and, by extension, the piston rod 509 to extend from the cylinder 512. As the piston head 508 moves along the cylinder 512, the magnet 506 moves along the sensor element 516 inside the pressure tube 504, which remains stationary during the movement of the piston rod 509. The pressure tube 504 extends through the piston head 508 through a sealed channel which prevents the pressurized fluid from exchanging between the two chambers of the cylinder 512. As the magnet 506 moves along the sensor element 516, the position sensor 502 determines the position of the piston head 508 within the cylinder. This position may be mapped to a position of the intermediate lift arm more generally, and that position may be transmitted to a display of the lift device. By placing the sensor element 516 inside the cylinder, it improves the reliability of the measuring system because it is protected from external damage. A valve block 505 may be used to selectively port pressurized hydraulic fluid to separate chambers within the cylinder 512. The valve block 505 may include a lid 503 that may be used to access the sensor element 516 and remove the sensor element 516 for service and/or replacement. In some embodiments, the hydraulic assembly 500 may include multiple sensor element 516 and/or magnet 506.

Turning now to FIG. 5D, an alternative and/or additional embodiment of the hydraulic assembly 500 is shown. The hydraulic assembly 500 of FIG. 5D may be substantially similar to the hydraulic assembly 500 of FIG. 5A, except as otherwise specified herein. The hydraulic assembly 500 may include a cylinder 512 and a piston rod 509. The cylinder 512 may have an internal cavity formed by an internal surface 536 of the cylinder 512 and may be any suitable shape, such as cylindrical or other prismatic shape. The piston rod 509 may be positioned in part within the cavity of the cylinder 512 and be configured to extend and/or retract within the cavity due to hydraulic pressure differentials between separate internal sections of the hydraulic assembly 500, as separated by the piston head 508. The piston head 508 is coupled to the piston rod 509 at a proximal end 534 of the piston rod 509. In some embodiments, the piston head 508 may be coupled to the piston rod 509 at one or more locations along the piston rod 509 not at the proximal end 534. In an exemplary embodiment, the piston head 508 is coupled to the piston rod 509 by a set screw 522. In other embodiments, the piston head 508 is coupled to the piston rod 509 by threaded connection (e.g., the piston head 508 is threaded onto the piston rod 509 at torque to prevent loosening of the piston head 508 from the piston rod 509). While the set screw 522 is shown in FIG. 5D, it is understood that any manner of connection between the piston head 508 and piston rod 509 may be utilized, such as threaded fastener connection, adhesive, and/or weld. Indeed, the piston head 508 and the piston rod 509 may be a unitary part in some implementations.

The hydraulic assembly 500 may additionally or alternatively include a pressure tube 504 with an interior cavity defined by an interior surface 538. The interior surface 538 may extend some or all of the length of the pressure tube 504 along a longitudinal axis of the pressure tube 504. Within the pressure tube 504 is housed a sensor element 516. The sensor element 516 may be a part of a magnetorestrictive sensor element that responds to magnetic fields (such as produced by the magnet 506) in the form of a mechanical strain pulse. For example, the sensor element 516 may be a flexible magnetorestrictive position sensor or a rigid magnetorestrictive position sensor. A position sensor 502 (as shown in FIG. 5B) may receive an indication of the mechanical strain pulse in the form of electrical signals. The received electrical signals may be filtered or otherwise corrected/adjusted to assign a value to the received signal. The signal may then be transmitted to a processor to determine a position of the magnet 506 (and by association, the piston rod 509) in relation to the sensor element 516.

To simplify assembly and production of the hydraulic assembly 500, the magnet 506 may be positioned between the piston rod 509 and the piston head 508. The magnet 506 may be located between magnet spacer 515, 517. A first face of the magnet spacer 515 may be proximally positioned at surface 526 to a retention plate 518 which has an outer diameter greater than an internal diameter 540 of the piston rod 509 so that the retention plate 518 may be positionally coupled to the piston rod 509 at a proximal face 524 of the 509. While the proximal face 524 is shown as the extreme position of the piston rod 509 at the proximal end 534, it should be understood that the proximal face 524 may be at any location on the piston rod 509. For example, the piston rod 509 may have a secondary internal surface with a diameter greater than the internal diameter 540. The retention plate 518 may be located within the secondary internal surface and the proximal face 524 may be a shoulder surface.

A second face of the one or more magnet spacer 515 may be positioned proximally to a first magnet face of the magnet 506 at the interface 528. A second magnet face of the magnet 506 may be positioned proximally to a third spacer face of the sensor element 516 at the interface 530. A fourth spacer face of the sensor element 516 may be positioned proximally to a washer face of a wave washer 520 (e.g., a compressible element or compressible spacer) or, alternatively, an internal face 532 of the piston head 508. While a wave washer is shown and described, it is understood additional or alternative components may be used such as a crush washer, foam, UHMW, or other crushable material.

In some embodiments, the magnet 506 is a hollow cylinder (e.g., an annular element) that is radially disposed about the pressure tube 504. Because the pressure tube 504 surrounds the sensor element 516 in some embodiments, the magnet 506 may also be radially disposed about the sensor element 516. However, in some embodiments, the magnet 506 may not be radially disposed about the sensor element 516. In such embodiments, the magnet 506 may be positioned proximate (but not necessarily in contact with) the sensor element 516 such that a magnetic field of the magnet 506 may induce a strain pulse through the sensor element 516.

The hydraulic assembly 500 may be used in, for example, a boom assembly that is used for extending and retracting a work platform, such as shown in the lift device 10 of FIG. 1. The boom assembly may include a base member and an extension member, each coupled to either the cylinder 512 or the piston rod 509. In at least one embodiment, the base member is coupled to the cylinder 512 and the extension member is coupled to a distal end (e.g., a distal end 542 as shown in FIG. 5A) of the piston rod 509 such that the extension member extends from within the base member when the piston rod 509 extends from within the cylinder 512. The distal end of the piston rod 509 may include one or more apertures through which the extension member may be rotatably coupled to the piston rod 509. In some embodiments, the base member is the upper lift arm 32c of FIG. 1 and the extension member is the intermediate lift arm 32d of FIG. 1. In some embodiments, the lift device (e.g., lift device 10 of FIG. 1) may include one or more hydraulic assembly 500 of FIG. 5 that are used to extend and/or retract one or more extension members from one or more base members.

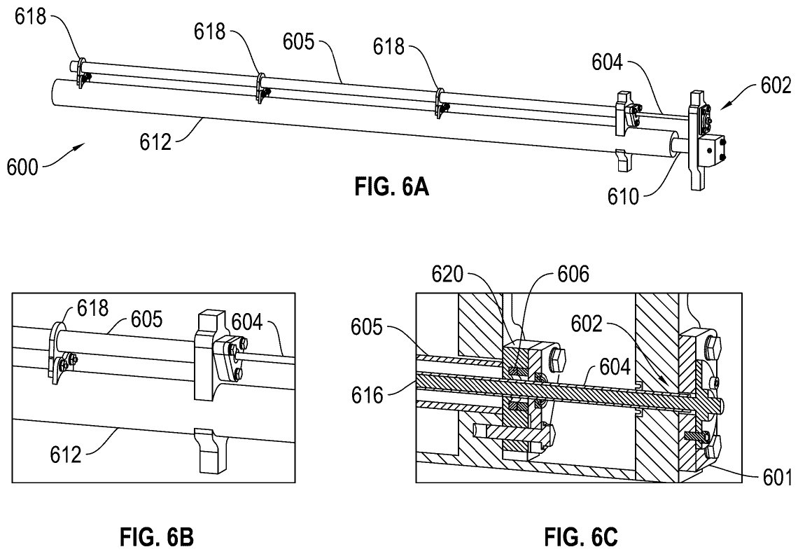

Turning now to FIGS. 6A-6C, various views of an exemplary position sensor 37 of FIG. 1 is shown. In the embodiment illustrated in FIGS. 6A-6C, a position sensor 602 is shown exterior to a hydraulic extender 600. The hydraulic extender 600 may comprise a cylinder 612 and a piston 610. The position sensor 602 may be any number of position sensors, including a magnetorestrictive position sensor or a Hall effect sensor. In an exemplary embodiment, the position sensor 602 is a magnetorestrictive position sensor. The position sensor 602 may include an inner tube 604, a sensing element 616, a sensing unit 601, a magnet 606, and an outer tube 605. In one embodiment (as shown in FIGS. 6A-6C), the outer tube 605 is removeably or fixedly coupled to the cylinder 612 by brackets 618. The sensing unit 601 may be removeably or fixedly coupled to the piston 610. The inner tube 604 is removeably or fixedly coupled to the sensing unit 601 such that as the piston 610 moves within the cylinder 612, the sensing unit 601 and the inner tube 604 move in a corresponding manner. Additionally, in some embodiments, the sensing element 616 is disposed within the inner tube 604 and is removeably coupled to the sensing unit 601 and moves accordingly. The magnet is housed in a magnet housing 620, which may be removeably or fixedly coupled to the cylinder 612. Thus, as the piston 610 moves within the cylinder 612, the sensing element 616 moves in relation to the magnet 606 and sends a signal to the sensing unit 601. This signal may be amplified, filtered, and used to determine a precise position of the piston 610 (and by extension, the intermediate lift arm 32d).

By placing the position sensor external to the cylinder, serviceability is increased. Additional advantages of the exterior placement of the position sensor include allowing alternate cylinder orientation (e.g., rod porting), allowing smaller cylinder sizing, and allowing the use of the position sensor in boom extension systems not using hydraulic cylinders.

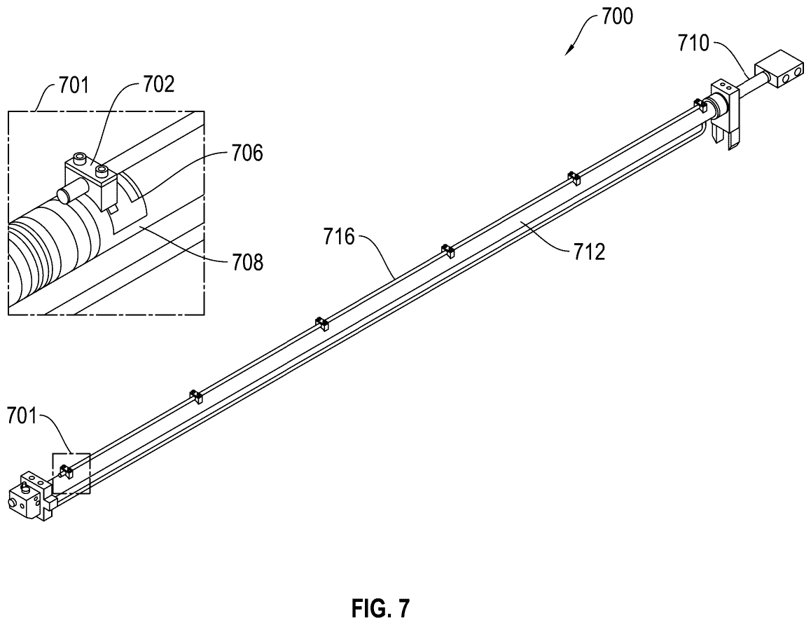

Turning now to FIG. 7, a hydraulic extender 700 is shown with a position sensor externally mounted to the cylinder 712. Unlike FIG. 6A, a magnet 706 is mounted internally in the cylinder 712 in FIG. 7. For example, the magnet 706 may be mounted onto the piston head 708. Alternatively, the magnet 706 may be mounted on a piston rod of the piston 710. Thus, as the piston head 708 (or piston rod) moves within the cylinder 712, the magnet 706 also moves. As the magnet 706 moves with the piston head 708, it moves in relation to the sensing element 716 which is statically coupled to the cylinder 712. The electromagnetic interaction between the sensing element 702 and the magnet 706 is measured by the sensing element 702. The control system of the lift device 10 may have a mapping software to map signals received from the sensing element 702 to a physical position of the piston 710. As with FIG. 5A, the cylinder 712 may be coupled to either the upper lift arm 32c or intermediate lift arm 32d of FIG. 1. The piston 710 may be coupled to the arm that the cylinder 712 is not coupled to. In this way, as the intermediate lift arm 32d extends and retracts with relation to the upper lift arm 32c, the magnet 706 moves in relation to the sensing element 716. A detailed view of section 701 illustrates the interior of the cylinder 712 with a magnet 706 positioned proximate the sensing element 716,

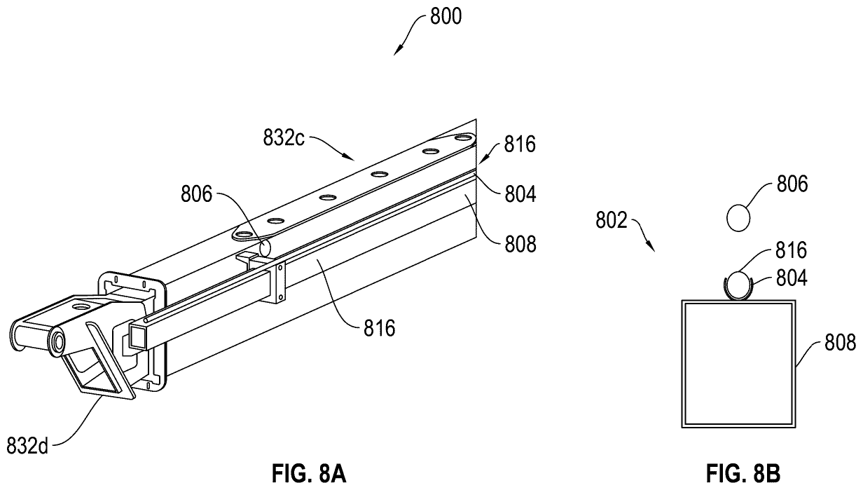

Turning now to FIGS. 8A-8B, a hydraulic extender 800 is shown with an externally mounted position sensor 802. The position sensor 802 may comprise a pushtube extrusion member 808. In some embodiments, this pushtube extrusion member 808 may be used to route hose and cables for the lift device 10 of FIG. 1. On an outer surface of the pushtube extrusion member 808 may be affixed a channel 804 to house the sensing element 816. In some embodiments, the channel 804 is fully enclosed around the sensing element 816. The channel 804 may be welded to the pushtube extrusion member 808 or otherwise affixed thereto (e.g., fastened, welded, riveted, etc.). In some embodiments, the pushtube extrusion member 808 is in unity with the channel 804 (e.g., part of the extrusion).

The pushtube extrusion member 808 is affixed (removeably or fixedly) to an outer surface of the upper lift arm 832c of the lift device 10 of FIG. 1. In an exemplary embodiment, the outer surface is on a lateral side of the upper lift arm 832c (as shown in FIG. 8A). In other embodiments, however, the pushtube extrusion member 808 may be affixed on a top, exterior surface of the upper lift arm 832c or a bottom surface of the upper lift arm 832c.

The sensing element 816 is housed within the channel 804, according to an exemplary embodiment. A magnet 806 is mounted (removeably or fixedly) to the extending intermediate lift arm 832d. Because the intermediate lift arm 832d moves in relation to the upper lift arm 832c, according to an embodiment, the magnet 806 moves in relation to the sensing element that is coupled to the static upper lift arm 832c. This allows a sensing unit (e.g., sensing unit 501 of FIG. 5) to determine a position of the intermediate lift arm 832d as it moves in and out of the upper lift arm 832c.

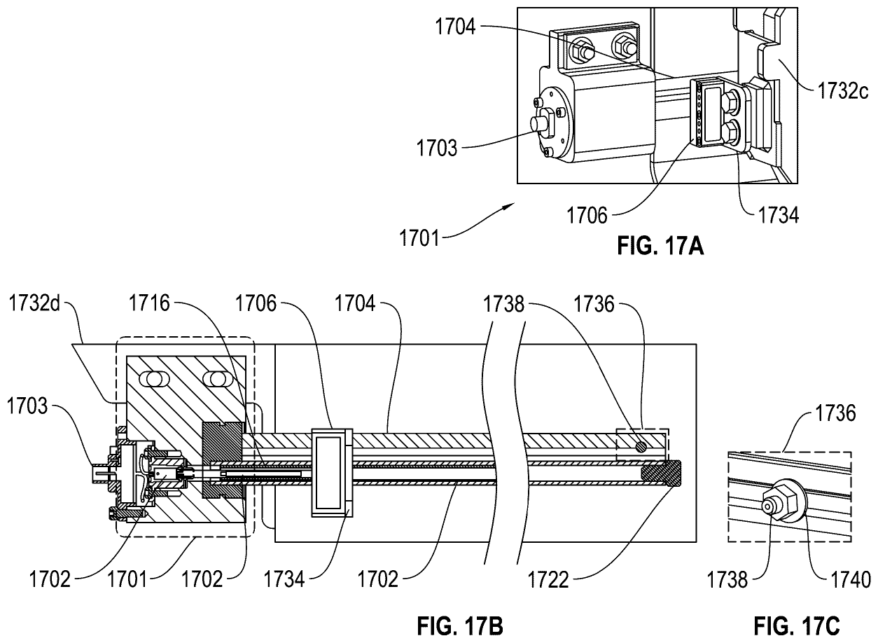

Turning briefly now to FIGS. 17A-17B, a sensing unit 1701 mounted to an exterior of a boom assembly of a lift vehicle is illustrated, according to an embodiment. In some embodiments, the implementation of the sensing unit 1701 of FIGS. 17A-17B may be substantially similar to that of FIGS. 8A-8B. In at least one embodiment, the sensing unit 1701 is mounted onto an arm 1732d of the boom assembly of the vehicle. In some embodiments, the arm 1732d may be substantially similar to one or more of the lower lift arm 32a, 32b, and/or 32c. The sensing unit 1701 may include a position sensor 1702, a lid 1703, a pressure tube 1704, a magnet 1706, and/or a sensing element 1716. The magnet 1706 may be mounted to a boom arm 1732c by mounting plate 1734, such that as the boom arm 1732c moves in relation to arm 1732d (whether the boom arm 1732c is moved or the arm 1732d is moved), the magnet 1706 moves (affixed to the boom arm 1732c) relative to the position sensor 1702 (affixed to the arm 1732d).

The pressure tube 1704 may be a custom extrusion tube, such as a custom aluminum extrusion tube. However, it is understood that the pressure tube 1704 may be any suitable material (e.g., steel, aluminum, magnesium, plastic, glass), shape (e.g., annular, circular, rectangular, prismatic, etc.), and/or orientation, such that the sensing element 1716 may be positioned therein. The pressure tube 1704 is coupled to the arm 1732d. In some embodiments, the pressure tube 1704 is coupled to the arm 1732d by a pressed-in insert 1738 extending from a side surface of the arm 1732d. The pressed-in insert 1738 may be spot welded, threaded, manufactured, adhered, etc. to the arm 1732d such that the pressure tube 1704 may coupled to the arm 1732d by the pressed-in insert 1738. For example, the pressure tube 1704 may have an aperture extending from one face to a second face through which the pressed-in insert 1738 may pass through. The pressed-in insert 1738 may also have a threaded end that may receive a threaded fastener, such as a nut 1740. The nut 1740 may threadedly engage with the pressed-in insert 1738 such that the pressure tube 1704 is fastened to the arm 1732d, as shown in connection portion 1736, and in isometric detail in FIG. 17C. Alternative or additional methods of coupling the pressure tube 1704 to the arm 1732d may include, by way of non-limiting example, adhesive, welding, thru-bolts, etc. It is understood that magnet 1706 and/or the sensing unit 1701 may be coupled to additional and/or alternative elements of the vehicle without digressing from the methods and systems described herein. For example, the magnet 1706 may be coupled to the arm 1732c, and the sensing unit 1701 may be coupled to the boom arm 1732c.

While FIGS. 17A-17C show the sensing unit 1701 coupled to the side of the arm 1732c and/or the 1732d, the sensing unit 1701 and/or the magnet 1706 may be coupled to any side, portion, section, or otherwise of their respective boom elements. For example, the sensing unit 1701 may be coupled to the bottom or top of the arm 1732d. Likewise, the vehicle may comprise multiple magnets 1706 and/or sensing units 1701.

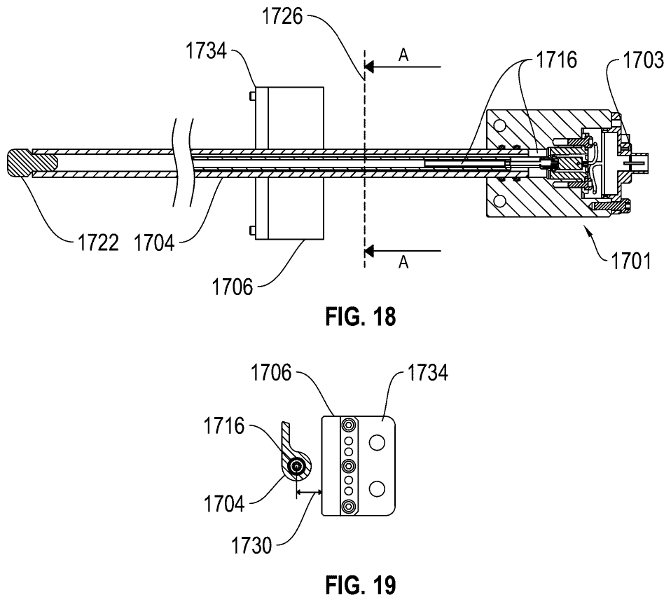

FIGS. 18A-18B illustrate additional embodiments of the sensing unit 1701. FIG. 19 is a section view 1726 of FIG. 18. A magnet distance 1730 is illustrated between the position sensor 1702 and the magnet 1706. The magnet distance 1730 is a distance in which the magnetic field of the magnet 1706 may affect a strain on the sensing element 1716.

The distal end of the pressure tube 1704 may accept a plug 1722, as shown in FIG. 17A. The plug 1722 may be positioned within an interior diameter of the pressure tube 1504 so as to seal the interior of the pressure tube 1704 from contaminants such as debris and/or fluids. The plug 1722 may include one or more male threads to engage with corresponding female threads on the interior surface of the pressure tube 1704. Alternatively or additionally, the plug 1722 may include female threads to threadedly engage with male threads on an exterior of the pressure tube 1704

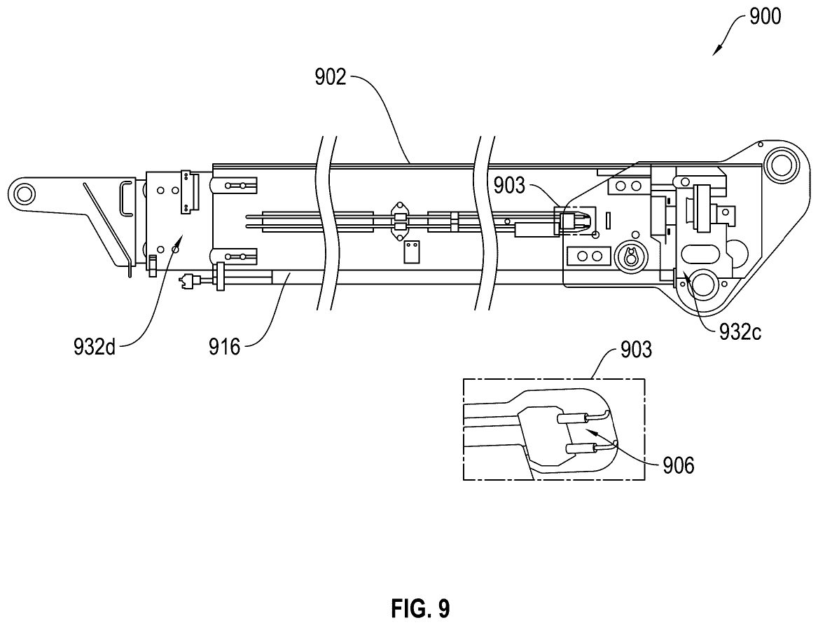

Turning back now to FIG. 9, a lift assembly 900 is shown with a position sensor 902. The position sensor 902 may any embodiment disclosed herein, including Hall effect sensors, magnetorestrictive position sensors, microwave position sensors, etc. In an exemplary embodiment, as shown in FIG. 9, the position sensor 902 is a magnetorestrictive position sensor. According to an embodiment, a sensing element 916 is mounted to an upper lift arm (e.g., upper lift arm 32c of FIG. 1) and configured to stay static in relation to the movement of an intermediate lift arm. As shown in FIG. 9, the upper lift arm is transparent and the intermediate lift arm 932d is shown. The upper lift arm and the intermediate lift arm 932d may be coupled by an extending member (e.g., a hydraulic piston and cylinder, rotating mechanical linkage, gear linkage, etc.). As the extending member moves (e.g., extends and retracts), the intermediate lift arm moves in and out of an internal cavity of the upper lift arm 932c. A magnet 906 is shown coupled (removeably or fixedly) to the intermediate lift arm 932d (as seen in the section 903). In this configuration, as the intermediate lift arm 932d moves in and out of the cavity of the upper lift arm 932c, the magnet 906 moves in relation to the sensing element 916. As the magnet moves along the sensing element 916, a sensing unit (e.g., the sensing unit 501 of FIG. 5) is able to determine the position of the magnet 906 in relation to the sensing element 916 and, by extension, the position of the intermediate lift arm 932d in relation to the upper lift arm.

This embodiment allows for the position sensor 902 to fit between the side sheets on all booms. This allows for better protection of the position sensor 902 because in the retracted position it is hidden from external damage.

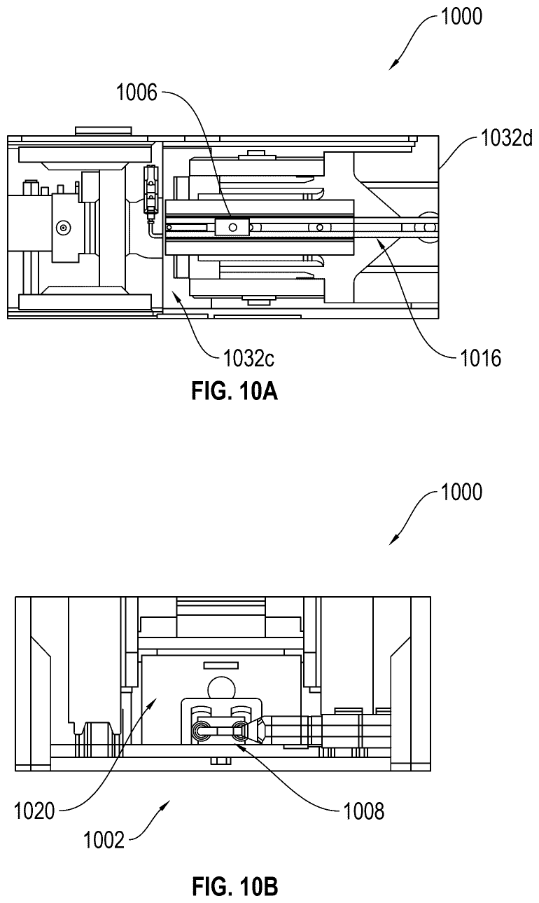

According to another embodiment, FIGS. 10A-10B show a lift assembly 1000 with a position sensor 1002 positioned externally thereon. According to an embodiment, a sensing element 1016 is statically coupled to an upper lift arm 1032c by one or more mounting clips 1008. A magnet 1006 is coupled to an intermediate lift arm 1032d. The intermediate lift arm 1032d is coupled to the upper lift arm 1032c by an extending element (e.g., a hydraulic cylinder and piston). As described here, as the intermediate lift arm 1032d is extended in and out of an inner channel of the upper lift arm 1032c, the magnet 1006 coupled to the intermediate lift arm 1032d moves along the sensing element 1016 without touching it. In some embodiments, a wear pad 1020 houses the magnet 1006. In some embodiments, the wear pad 1020 is positioned between a lower surface of the intermediate lift arm 1032d and a lower inner surface of the upper lift arm 1032c. This wear plate allows the two arms 1032c, 1032d to slide past each other during extension and retraction with minimal friction and wear to the arms 1032c, 1032d. In some embodiments, the sensing element(s) 1016 are disposed in channels in the wear pad 1020.

As discussed herein, the position sensor 37 of FIG. 1 may be a Hall effect sensor or a magnetorestrictive position sensor. However, several other embodiments are disclosed herein. For example, the position sensor 37 of FIG. 1 may also be a laser or LED length sensing sensor, a microwave sensing unit, a rotary encoder, or a potentiometer.

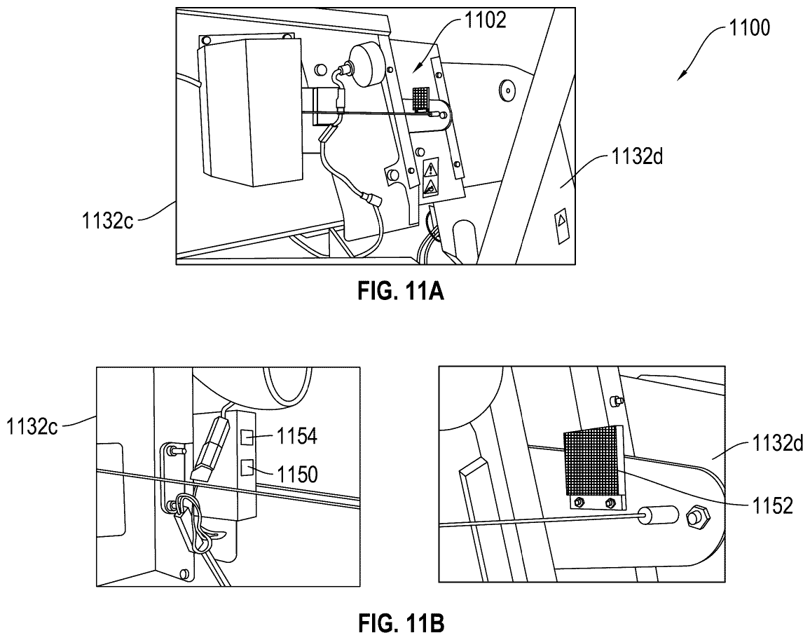

As shown in FIGS. 11A-11B, a laser/LED length sensing unit 1102 is shown on a lift assembly 1100. The lift assembly 1100 may comprise an upper lift arm 1132c and an intermediate lift arm 1132d. Coupled to the upper lift arm 1132c is an emitter 1150. A reflector 1152 is positioned on the intermediate lift arm 1132d. The sensing unit 1102 may be any one of several photoelectric sensor embodiments. For example, the sensing unit 1102 may employ triangulation technology and/or time-of-flight sensing technology.

In a triangulation embodiment, the emitter 1150 emits a beam of light (typically infrared) towards the reflector 1152. When the light beam encounters the reflector 1152, it reflects or scatters the light. A receiver 1154 detects the reflected or scattered light. By measuring the angle or position of the received light, sensing unit 1102 can calculate the distance between the receiver 1154 and the reflector 1152 using triangulation principles. The receiver 1154 typically uses lenses or optics to focus the received light onto a position-sensitive detector (PSD) or an array of photodiodes. Based on the detected position of the light on the PSD or photodiode array, the receiver 1154 can determine the distance to the reflector 1152. Because the reflector 1152 is coupled to the intermediate lift arm 1132d in a known position in relation to the upper lift arm 1132c, the sensing unit 1102 can employ a mapping technique using the known position to determine the position/distance of the intermediate lift arm 1132d with respect to the upper lift arm 1132c or the lift device 10 of FIG. 1, or any known datum.

In a time-of-flight embodiment, time-of-flight sensors (e.g., the sensing unit 1102) use the speed of light to measure distances. The emitter 1150 emits short pulses of light (often laser pulses) towards the reflector 1152. The emitted light reflects off the reflector and returns to a receiver 1154. The receiver 1154 measures the time it takes for the light pulse to travel to the reflector 1152 and back. Since the speed of light is known, the receiver 1154, and the sensing unit generally, can calculate the distance between the reflector 1152 and the receiver 1154. The time-of-flight sensors may use specialized detectors, such as avalanche photodiodes, to detect the returning light pulses accurately.

In some embodiments, the reflector 1152 may be integrated into the intermediate lift arm 1132d and may be any material that reflects light (visible or otherwise). In some embodiments, the reflector 1152 is made of a specific material with high reflectivity, such as metal, plastic, glass, or an optical film.

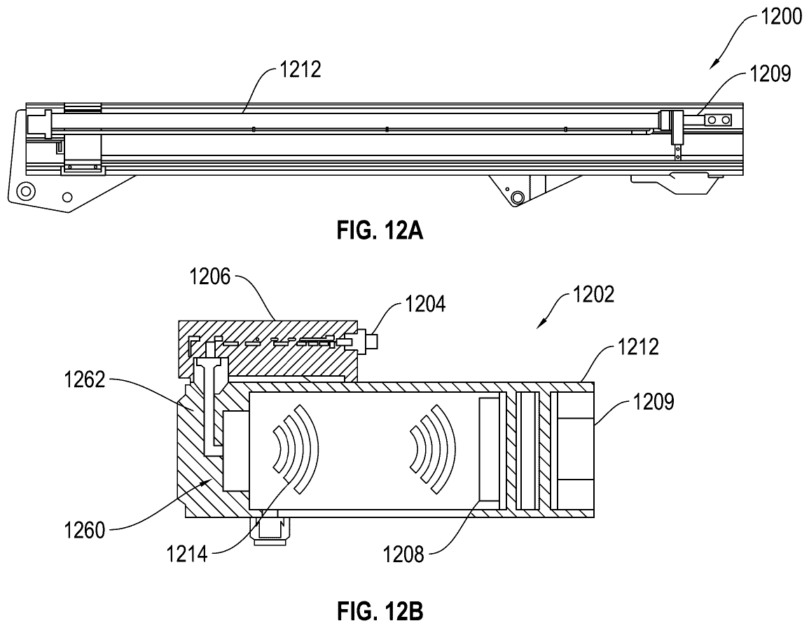

FIGS. 12A-12B illustrate a lift assembly 1200 with an integrated internal position sensor 1202. In an exemplary embodiment, the internal position sensor 1202 is a microwave position sensor integrated into a hydraulic cylinder 1212. The position sensor 1202 may include an antenna 1260, a T Card 1262, a sensor 1206, and a connector 1204.

In an embodiment, the microwave position sensor 1202 functions in the following manner: the antenna 1260 emits short pulses of microwave signals 1214, typically in the gigahertz range. These signals propagate in the cylinder 1212 in a directional beam. When the emitted microwave signals 1214 encounter objects (e.g., a piston head 1208) in their path, a portion of the energy is reflected back towards the sensor antenna 1260. The antenna 1260 has a receiver that captures the reflected microwave signals 1214. The receiver is designed to detect and process these signals 1214, for example, through sensor 1206. By measuring the time it takes for the emitted microwave signals 1214 to travel to the object and back, the sensor can calculate the distance to the piston head 1208 of the piston 1209. The sensor's 1206 electronics analyze the received signals and process the data to extract relevant information. This can involve filtering out noise, performing calculations, and interpreting the signal characteristics. By combining information from multiple reflected signals, the sensor can determine the position or distance of objects within its field of view. This information can be used for various purposes, such as object detection, tracking, or proximity sensing.

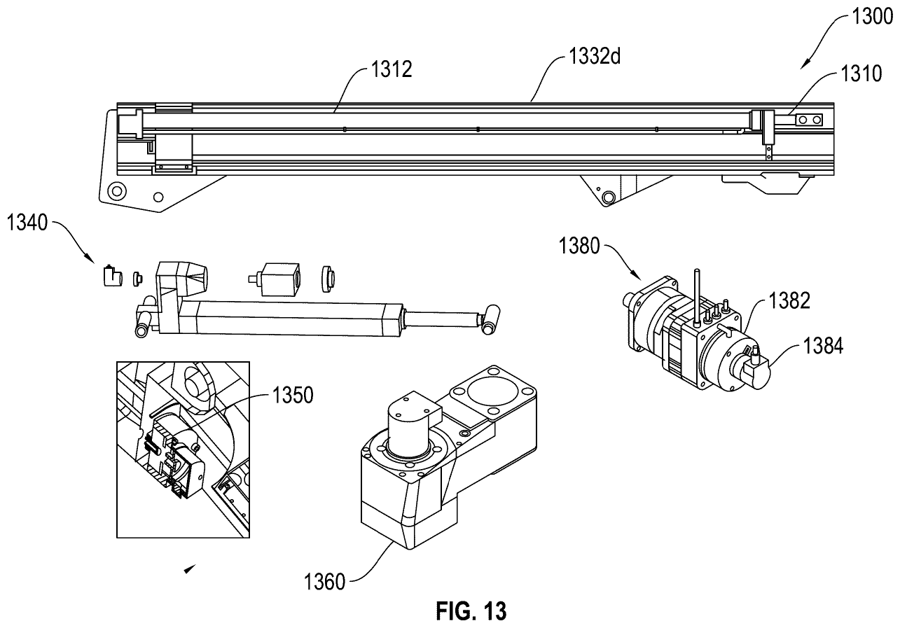

Turning now to FIG. 13, a lift assembly 1300 is shown comprising a cylinder 1312, a piston 1310, an upper lift arm, and an intermediate lift arm 1332d. The cylinder 1312, the piston 1310, the upper lift arm, and the intermediate lift arm 1332d may be of a similar structure as described herein with regard to various other figures. However, in other embodiments, the lift assembly 1300 comprises a linear actuator 1340 which converts rotational movement into linear motion. For example, through the use of a motor and/or gearbox. In one embodiment, a motor 1380 is coupled to a brake 1382. An encoder 1384 is mounted through the brake 1382 and the motor 1380. An example of an encoder is shown as the encoder 1360. An exemplary motor 1350 is shown.

To determine linear position using the encoder 1360, it is mechanically connected to the linear actuator 1340, which may be a lead screw, rack and pinion gear, or belt. As the linear actuator 1340 moves, it causes the attached encoder 1360 to rotate. The encoder consists of a rotating disc or wheel with evenly spaced marks or slots, along with a sensor (optical or magnetic) that detects these marks as the disc rotates.

When the marks pass by a sensor internal to the encoder 1360, it generates electrical signals. The specific pattern and timing of these signals depend on the encoding scheme used by the rotary encoder 1360, which can be incremental or absolute. These signals are then processed by electronic circuitry, which interprets the rotation of the encoder 1360 and converts it into linear displacement based on the known mechanical characteristics of the linear actuator 1340.

For accurate linear position determination, calibration and scaling procedures may be necessary. These procedures establish a precise relationship between the rotation of the encoder 1360 and the corresponding linear position, ensuring reliable and accurate measurements.

By combining the rotational information from the encoder 1360 with the mechanical characteristics of the linear motion mechanism, the system can estimate and track the linear position based on the output of the encoder.

In some embodiments, the linear actuator 1340 is coupled at one to the upper lift arm and coupled to the intermediate lift arm 1332d at another end. In this way, as the linear actuator 1340 is actuated by the motor 1380, the intermediate lift arm 1332d is translated in relation to the upper lift arm 1332d, thus resulting in a telescoping movement.

In FIG. 13, the encoder 1360 is shown mounted to the back of a linear actuator gearbox, however, alternative packaging variations may include mounting the encoder 1384 through the brake and/or mounting through the motor. It should be noted, that the rotary encoder embodiment may be used to measure the linear position of the intermediate lift arm 1332d in any mechanism utilizing rotary motion to cause linear motion. Similar encoder mounting/technology could also be applied to measure machine rotation (i.e., platform or turntable).

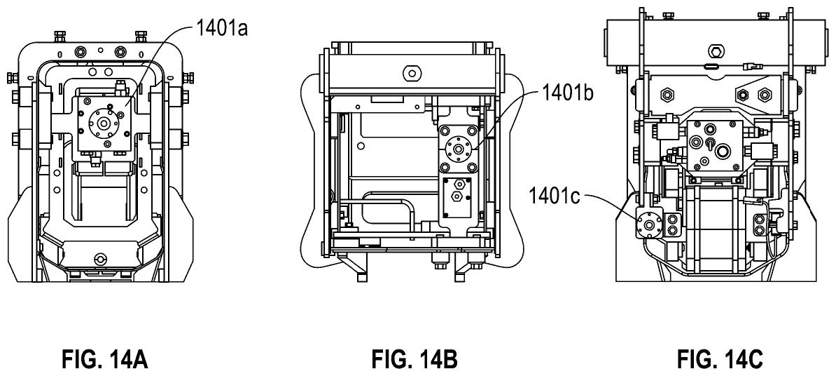

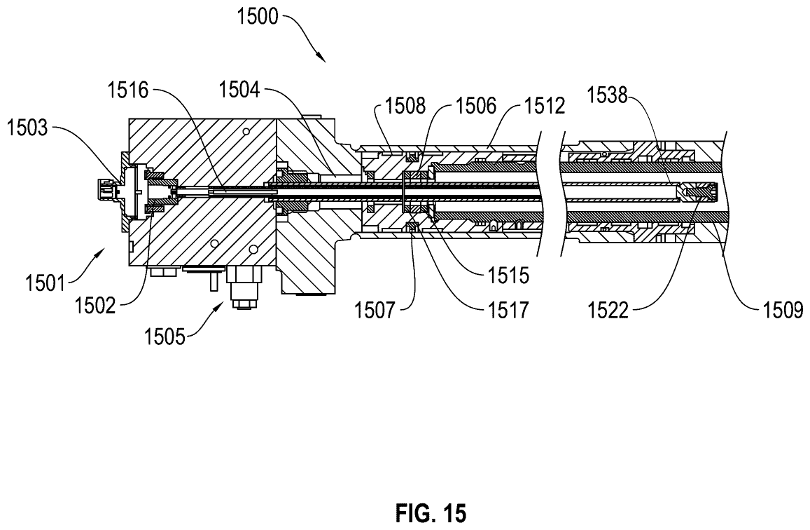

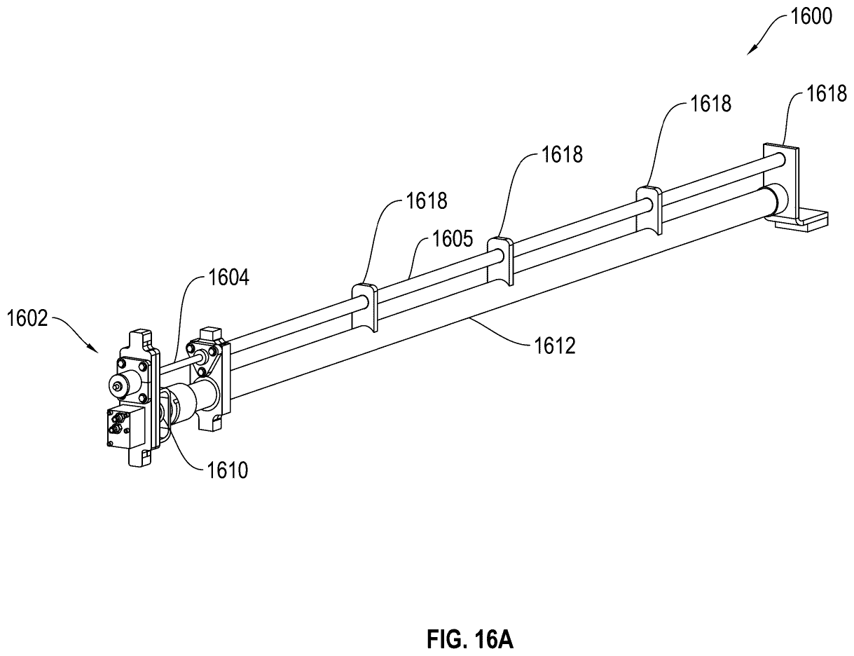

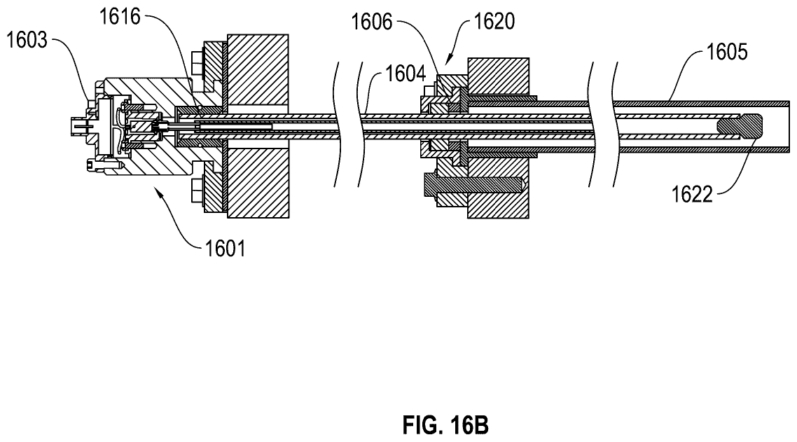

Turning now to FIGS. 14A-16C, various implementations of the methods and systems described herein are illustrated according to an embodiment. FIG. 14A is a rear-view of an in-cylinder sensing unit 1401a with a sensing element (e.g., sensing element 1516 of FIG. 15) mounted within a hydraulic cylinder, according to an embodiment. FIG. 14B is a rear-view of an externally mounted sensing unit 1401b with a sensing element (e.g., sensing element 1616 of FIG. 16B) external to a hydraulic cylinder, according to an embodiment. FIG. 14C is a rear-view of an externally mounted sensing unit 1401c with a sensing element (e.g., sensing element 1716 of FIG. 17) mounted external to a hydraulic cylinder, according to an embodiment.

Turning now to FIG. 15, a sensing unit 1501 implemented in the interior of a hydraulic assembly 1500 is illustrated, according to an embodiment. The hydraulic assembly 1500 may comprise a piston rod 1509 and a cylinder 1512, fluidly coupled to one another. Specifically, the piston rod 1509 may be received within the cylinder 1512. The piston rod 1509 may include a seal 1507 to separate a first portion of the cylinder 1512 from a second portion of the cylinder 1512, such that the two portions (e.g., the two inner volumes) are separated by the seal 1507 as the piston rod 1509 moves within the cylinder 1512. Accordingly, the piston rod 1509 may be extended within the cylinder 1512 to an extended position or retracted into the cylinder 1512 into a retracted position by adding pressurized fluid (e.g., hydraulic oil) to one or more of the two inner volumes. The piston rod 1509 is positioned within the cylinder 1512, and the seal 1507 creates a fluid-tight seal with an inner surface of the cylinder 1512. The piston rod 1509 may also be fixedly coupled to a member of the lift assembly 14 of FIG. 1. In some embodiments, the piston rod 1509 is coupled to the upper lift arm 32c and the cylinder 1512 is coupled to the intermediate lift arm 32d. In this embodiment, as the piston and cylinder translate into an extended position by hydraulically pressurizing the second portion of the cylinder, the intermediate lift arm 32d moves into an extended position. In some embodiments, the piston rod 1509 is coupled to the intermediate lift arm 32d and the cylinder is coupled to the upper lift arm 32c of FIG. 1. In substantially the same manner, the upper lift arm 32c and the intermediate lift arm 32d are adjusted into the extended position as the cylinder 1512 and piston rod 1509 extend.

The hydraulic assembly 1500 may also comprise a position sensor 1502. The position sensor 1502 may be coupled to a second end of the cylinder 1512. As shown in FIG. 15, the position sensor 1502 may include a sensor element 1516 inside a pressure tube 1504 (the sensor element 1516 being either flexible or rigid), a magnet 1506, and a sensing unit 1501 or sensor. The sensing unit 1501 may be a Hall effect sensor or magnetorestrictive position sensor.

The magnetorestrictive position sensor is a type of sensor used to measure the position, displacement, or level of an object, such as the position of the piston rod 1509 in the cylinder 1512. The sensing unit 1501 utilizes the principle of magnetostriction, which is the property of certain materials to change their shape or dimensions when subjected to a magnetic field.

In a magnetorestrictive position sensor, a sensing element or waveguide (e.g., sensor element 1516 inside the pressure tube 1504) made of a magnetorestrictive material, such as Terfenol-D, Metglas 2605SC, cobalt ferrite, nickel, or Galfenol, is used. The sensing element may be a thin metal wire or rod (e.g., sensor element 1516 inside the pressure tube 1504) that is placed in close proximity to a permanent magnet (e.g., magnet 1506).

When an electrical current pulse is passed through the sensor element 1516 inside the pressure tube 1504, it generates a magnetic field that interacts with the permanent magnet 1506. This interaction causes the magnetorestrictive material (e.g., the sensor element 1516 inside the pressure tube 1504) to experience a strain, resulting in a mechanical wave or “strain wave” propagating along the sensor element 1516 inside the pressure tube 1504.

To determine the position of the piston rod 1509 in the cylinder 1512 (and by association, the position of the intermediate lift arm 32d in relation to the upper lift arm 32c), a pickup or transducer (e.g., the position sensor 1502) is placed along the sensing element 1516 to detect the strain wave. The transducer converts the mechanical strain into an electrical signal, which is then processed to determine the precise position of the piston within the cylinder 1512.

In some embodiments, the position sensor 1502 is a Hall effect sensor. The Hall effect sensor may function in the following manner to determine the position of the piston rod 1509 in relation to the cylinder 1512. The Hall effect sensor may comprise a thin strip or plate of semiconductor material (e.g., sensor element 1516 inside the pressure tube 1504) with current flowing through it. When a magnetic field is applied perpendicular to the direction of the current, the Lorentz force acts on the charge carriers (electrons or holes) within the material. The Lorentz force causes the charge carriers to be deflected towards one side of the semiconductor material, resulting in an accumulation of charge carriers on one edge and a depletion of charge carriers on the opposite edge. This creates a voltage difference, known as the Hall voltage, across the material. The Hall voltage may be measured using the position sensor's 1502 built-in electrodes or contacts placed along the edges of the semiconductor strip. These electrodes pick up the voltage difference created by the Hall effect. The Hall voltage is proportional to the strength of the magnetic field and can be positive or negative depending on the polarity of the magnetic field and the type of charge carriers (electrons or holes) in the material. The output signal from the Hall effect sensor can be analog (continuous voltage) or digital (on/off signal) depending on the sensor's design and application. By measuring the Hall voltage, the Hall effect sensor can determine the presence, strength, and polarity of the magnetic field. It can detect magnetic fields from permanent magnets (e.g., magnet 1506), electromagnets, or magnetic field changes induced by moving objects.

In embodiments with the sensor element 1516 inside the pressure tube 1504 being flexible, serviceability is increased, and the sensor element 1516 inside the pressure tube 1504 may be extracted from the cylinder 1512 without contaminating the system by unscrewing the lid 1503 from the sensing unit 1501.

In operation of the lift device 10 of FIG. 1, upon the control system receiving a command to extend the intermediate lift arm 32d, the hydraulic assembly 1500 pressurizes one of the two chambers of the cylinder 1512 created by the piston rod 1509 to apply a force upon a piston head 1508 of the piston rod 1509. This pressure causes the piston rod 1509 to move and, by extension, the piston rod 1509 to extend from the cylinder 1512. As the piston head 1508 moves along the cylinder 1512, the magnet 1506 moves along the sensor element 1516 inside the pressure tube 1504, which remains stationary during the movement of the piston rod 1509. The pressure tube 1504 extends through the piston head 1508 through a sealed channel which prevents the pressurized fluid from exchanging between the two chambers of the cylinder 1512. As the magnet 1506 moves along the sensor element 1516, the position sensor 1502 determines the position of the piston head 1508 within the cylinder. This position may be mapped to a position of the intermediate lift arm more generally, and that position may be transmitted to a display of the lift device. By placing the sensor element 1516 inside the cylinder, it improves the reliability of the measuring system because it is protected from external damage. A valve block 1505 may be used to selectively port pressurized hydraulic fluid to separate chambers within the cylinder 1512. The valve block 1505 may include a lid 1503 that may be used to access the sensor element 1516 and remove the sensor element 1516 for service and/or replacement. In some embodiments, the hydraulic assembly 1500 may include multiple sensor element 1516 and/or magnet 1506.

The hydraulic assembly 1500 may additionally or alternatively include a pressure tube 1504 with an interior cavity defined by an interior surface 1538. The interior surface 1538 may extend some or all of the length of the pressure tube 1504 along a longitudinal axis of the pressure tube 1504. Within the pressure tube 1504 is housed a sensor element 1516. The sensor element 1516 may be a part of a magnetorestrictive sensor element that responds to magnetic fields (such as produced by the magnet 1506) in the form of a mechanical strain pulse. For example, the sensor element 1516 may be a flexible magnetorestrictive position sensor or a rigid magnetorestrictive position sensor. A position sensor 1502 (as shown in FIG. 15B) may receive an indication of the mechanical strain pulse in the form of electrical signals. The received electrical signals may be filtered or otherwise corrected/adjusted to assign a value to the received signal. The signal may then be transmitted to a processor to determine a position of the magnet 1506 (and by association, the piston rod 1509) in relation to the sensor element 1516. To simplify assembly and production of the hydraulic assembly 1500, the magnet 1506 may be positioned between the piston rod 1509 and the piston head 1508. The magnet 1506 may be positioned between a first spacer 1515 and a second spacer 1517, as shown in FIG. 15.

In some embodiments, the magnet 1506 is a hollow cylinder (e.g., an annular element) that is radially disposed about the pressure tube 1504. Because the pressure tube 1504 surrounds the sensor element 1516 in some embodiments, the magnet 1506 may also be radially disposed about/around the sensor element 1516. However, in some embodiments, the magnet 1506 may not be radially disposed about the sensor element 1516. In such embodiments, the magnet 1506 may be positioned proximate (but not necessarily in contact with) the sensor element 1516 such that a magnetic field of the magnet 1506 may induce a strain pulse through the sensor element 1516. The pressure tube 1504 may be open at a distal end. The distal end of the pressure tube 1504 may accept a plug 1522, as shown in FIG. 15. The plug 1522 may be positioned within an interior diameter of the pressure tube 1504 so as to seal the interior of the pressure tube 1504 from contaminants such as debris and/or fluids. The plug 1522 may include one or more male threads to engage with corresponding female threads on the interior surface of the pressure tube 1504. Alternatively or additionally, the plug 1522 may include female threads to threadedly engage with male threads on an exterior of the pressure tube 1504. In some embodiments, the plug 1522 may extend to an interior surface of the piston rod 1509, so as to support the distal end of the pressure tube 1504 from bending away from a longitudinal axis of the piston rod 1509.

The hydraulic assembly 1500 may be used in, for example, a boom assembly that is used for extending and retracting a work platform, such as shown in the lift device 10 of FIG. 1. The boom assembly may include a base member and an extension member, each coupled to either the cylinder 1512 or the piston rod 1509. In at least one embodiment, the base member is coupled to the cylinder 1512 and the extension member is coupled to a distal of the piston rod 1509 such that the extension member extends from within the base member when the piston rod 1509 extends from within the cylinder 1512. The distal end of the piston rod 1509 may include one or more apertures through which the extension member may be rotatably coupled to the piston rod 1509. In some embodiments, the base member is the upper lift arm 32c of FIG. 1 and the extension member is the intermediate lift arm 32d of FIG. 1. In some embodiments, the lift device (e.g., lift device 10 of FIG. 1) may include one or more hydraulic assembly 1500 of FIG. 15 that are used to extend and/or retract one or more extension members from one or more base members.

Turning now to FIGS. 16A-16BC, various views of an exemplary position sensor 37 of FIG. 1 is shown. In the embodiment illustrated in FIGS. 16A-16C, a sensor unit 1601 is shown positioned exterior to a hydraulic extender 1600. The hydraulic extender 1600 may comprise a cylinder 1612 and a piston 1610. The position sensor 1602 may be any number of position sensors, including a magnetorestrictive position sensor or a Hall effect sensor. In an exemplary embodiment, the position sensor 1602 is a magnetorestrictive position sensor. The position sensor 1602 may include an inner tube 1604, a sensing element 1616, a sensing unit 1601, a magnet 1606, and an outer tube 1605. In one embodiment (as shown in FIGS. 16A-6C), the outer tube 1605 is removeably or fixedly coupled to the cylinder 1612 by brackets 1618. The sensing unit 1601 may be removeably or fixedly coupled to the piston 1610. The inner tube 1604 is removeably or fixedly coupled to the sensing unit 1601 such that as the piston 1610 moves within the cylinder 1612, the sensing unit 1601 and the inner tube 1604 move in a corresponding manner. Additionally, in some embodiments, the sensing element 1616 is disposed within the inner tube 1604 and is removeably coupled to the sensing unit 1601 and moves accordingly. The magnet is housed in a magnet housing 1620, which may be removeably or fixedly coupled to the cylinder 1612. Thus, as the piston 1610 moves within the cylinder 1612, the sensing element 1616 moves in relation to the magnet 1606 and sends a signal to the sensing unit 1601. This signal may be amplified, filtered, and used to determine a precise position of the piston 1610 (and by extension, the intermediate lift arm 32d). The sensing element 1616 may be easily removed for replacement or repair by removing a lid 1603.

The distal end of the inner tube 1604 may accept a plug 1622, as shown in FIG. 16B. The plug 1622 may be positioned within an interior diameter of the pressure tube 1604 so as to seal the interior of the inner tube 1604 from contaminants such as debris and/or fluids within the pseudo cylinder (e.g., the outer tube 1605). The plug 1622 may include one or more male threads to engage with corresponding female threads on the interior surface of the inner tube 1604. Alternatively or additionally, the plug 1622 may include female threads to threadedly engage with male threads on an exterior of the pressure tube 1604.

By placing the position sensor external to the cylinder, serviceability is increased. Additional advantages of the exterior placement of the position sensor include allowing alternate cylinder orientation (e.g., rod porting), allowing smaller cylinder sizing, and allowing the use of the position sensor in boom extension systems not using hydraulic cylinders.

It should be understood that the embodiments and descriptions disclosed herein may be coupled together to measure multiple aspects of the lift assembly 14 of FIG. 1. For example, one or more position sensors disclosed herein may be used to measure the distance of multiple booms and telescoping members of the lift device 10.

### Configuration of the Exemplary Embodiments

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing control systems including computer processors, processing circuitry, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon that cause processing circuitry to perform multiple actions. Such machine-readable media can be any available media that can be accessed by a general purpose or special purpose computer (e.g., processing circuitry) or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the lift device 10 and control system as shown in the various exemplary embodiments is illustrative only. Additionally, any element disclosed in one embodiment may be incorporated or utilized with any other embodiment disclosed herein. For example, the techniques of the platform sensors 202 of the exemplary embodiment shown in at least FIG. 13 may be incorporated in the lift device 10 of the embodiment shown in at least FIG. 5. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A lift device comprising:
a boom assembly comprising a base member and an extension member; and
a hydraulic assembly comprising:
a cylinder housing having an internal cavity,
a piston positioned at least partially within the internal cavity and coupled to the extension member at a distal end of the piston,
a piston head coupled to the piston at a proximal portion of the piston, the piston head located within the cylinder,
a pressure tube extending through the piston head and at least a portion of the piston,
a sensor element extending within the pressure tube, and
a magnet positioned between the piston head and the proximal end of the piston.

2. The lift device of claim 1, further comprising a first magnet spacer positionally proximate the magnet at a first face of the magnet and a second magnet spacer positionally proximate the magnet at a second face of the magnet.

3. The lift device of claim 1, wherein the magnet is a hollow cylinder radially disposed about the pressure tube.

4. The lift device of claim 3, wherein the magnet is positioned between an internal face of the piston head and a proximal face of the cylinder.

5. The lift device of claim 4, further comprising:
a retention plate having a first face positionally proximate the proximal face of the cylinder;
a first spacer having a first spacer face positionally proximate a second face of the retention plate and a second spacer face of the first spacer positionally proximate a first magnet face of the magnet; and
a second spacer having a third spacer face positionally proximate a second magnet face of the magnet.

6. The lift device of claim 5, further comprising a wave washer having a first washer face positionally proximate a fourth spacer face of the second spacer, and a second washer face positionally proximate an internal face of the piston head.

7. The lift device of claim 5, wherein a fourth spacer face of the second spacer is positionally proximate an internal face of the piston head.

8. The lift device of claim 1, wherein the sensor element is magnetorestrictive wire.

9. The lift device of claim 1, further comprising a plug coupled to a distal end of the pressure tube, the plug sealing an interior of the pressure tube from the interior of the cylinder.

10. The lift device of claim 1, wherein the sensor element extends through a position sensor, wherein the position sensor is an induction pickup coil.

11. A lift device comprising:
a base assembly;
a boom assembly coupled with the base assembly and configured to extend and retract, the boom assembly comprising:
an extension member,
a base member, configured to house the extension member,
a cylinder coupled to the base member, and
a piston positioned at least partially within the cylinder and coupled to the extension member and configured to extend the extension member;
a platform assembly coupled with an end of the extension member of the boom assembly, the platform assembly configured to be raised and lowered by the boom assembly; and
a control system comprising processing circuitry configured to:
receive, from a sensor internal to the cylinder, a signal corresponding to a position of the extension member in relation to the base member,
assign a value to the signal,
determine, based on the value, a position of the extension member, and transmit the position of the extension member.

12. The lift device of claim 11, wherein the sensor uses microwaves to measure the position of the extension member.

13. The lift device of claim 11, wherein the sensor is a magnetorestrictive position sensor housed within a pressure tube extending within the cylinder.

14. The lift device of claim 11, wherein the sensor uses microwaves to measure the position of the extension member.

15. A lift device comprising:
a base assembly;
a boom assembly coupled with the base assembly and configured to extend and retract, the boom assembly comprising:
an extension member,
a base member, configured to house the extension member, and
a cylinder coupled to the base member and the extension member and configured to extend the extension member;
a platform assembly coupled with an end of the extension member of the boom assembly, the platform assembly configured to be raised and lowered by the boom assembly; and
a control system comprising processing circuitry configured to:
receive, from a sensor external to the cylinder, a signal corresponding to a position of the extension member in relation to the base member;
assign a value to the signal;
determine, based on the value, a position of the extension member; and
transmit the position of the extension member.

16. The lift device of claim 15, wherein the sensor is a magnetorestrictive sensor comprising a magnet and a sensing element.

17. The lift device of claim 16, wherein the magnet is coupled to the base member.

18. The lift device of claim 16, wherein the magnet is coupled to the extension member.

19. The lift device of claim 15, further comprising:
a magnetorestrictive wire coupled to the base member; and
a magnet coupled to the extension member.

20. The lift device of claim 19, wherein the magnet moves relative to the magnetorestrictive wire during movement of the extension member.
